(19) United States
(12) Patent Application Publication
(10) Pub. No.: US 2002/0055888 A1
(43) Pub. Date: May 9, 2002

(54) Internet-based commerce system

(75) Inventors: James G. Beran, San Diego, CA (US); Kenneth D. Tollefson, San Diego, CA (US)

Correspondence Address: LYON & LYON LLP, 633 WEST FIFTH STREET, SUITE 4700, LOS ANGELES, CA, 90071, US

(73) Assignee: SICOMMNET, INC., San Diego, CA

(21) Appl. No.: 10/035,403

(22) Filed: Dec. 28, 2001

Related U.S. Application Data
(63) Continuation of application No. 09/477,054, filed on Jan. 3, 2000.
(60) Provisional application No. 60/132,337, filed on May 3, 1999.

(51) Int. Cl. G06F 17/60

(52) U.S. Cl. 705/26

(57) ABSTRACT

An internet-based commerce system simultaneously usable by multiple purchasing organizations and multiple vendors while controlled by a virtual single server and database is disclosed. The commerce system handles the requisitions for goods and services by system users within a purchasing organization and directs requisitions to other users for approval within that purchasing organization using approval routes electronically established within the database. Requisitions are electronically processed into Requests for Quotation, Requests for Proposal, Requests for Information or Requests for Bid that are then released to the Internet for electronic responses by users representing vendors who access the system. Vendors with profiles matching the requests are actively notified of the requests preferably through response-prompting electronic mail. Using the system, users profiled by the system as buyers for the purchasing organizations process the electronic responses into awards. The system then notifies the awardees and makes available information about the awards to other vendors. The system enables each purchasing organization to have its own unique electronic catalog of goods and services to simplify and standardize the procurement process within the organization, while the system uses a basic catalog, preferably the NIGP code, as a backbone for screening and communicating with vendors. Further, because the system operates with one virtual server and database, compilation and sharing of any data that is stored on the system are possible. For example, vendor performance, user workload data can be compiled and shared within an agency or agencies using data search, compilation and representation software tools that known in the art. Similarly, users are preferably restricted, in accordance with user identifications used to access the commerce system, to a subset of data records in the database.

This continuation-in-part application claims priority to U.S. Provisional Application Serial No. 60/132,337 filed May 3, 1999 having the title “Internet-Based Commerce System,” and which is fully incorporated herein by reference.

### BACKGROUND OF THE INVENTION

The present invention relates to the field of electronic commerce. In particular, the present invention relates to a computer and Internet-based commerce system for handling the request, bidding, and procurement activities between agencies, organizations and businesses and an array of vendors for commodities, including goods and services.

In recent years, many Internet-based systems for processing requests for quotations for goods and/or services and then handling responses from compatible sellers have been disclosed and developed. For example, U.S. Pat. No. 5,758,328 issued to Giovannoli and incorporated herein by reference, discloses a computer-based communications network in which buyers and suppliers that are registered in the system communicate requests for goods and/or services and responses to requests. Moreover, systems for routing and processing procurement information to different personnel within an organization are also known. U.S. Pat. No. 5,361,199 issued to Shoquist et al., also incorporated herein by reference, describes system programming that receives data from a buyer and routes the document data to other personnel involved in a procurement processing scheme. However, even with the wide proliferation in recent years of computer and Internet-based commerce, a system that can fully service the procurement administration requirements of many organizations and vendors all at once has yet to be developed. Further, the prior art computer and Internet-based commerce systems that apply a commodity code catalog to standardize communication between system users cannot tailor the commodity catalog to the needs of individual users. A need therefore exists for procurement system that enables any individual within a large or small organization to purchase any goods and/or services available from vendors who access the system. A need further exists for a system that enables multiple agencies, businesses and organizations to electronically process their requests for goods and services, communicate these requests to interested vendors, accept electronic responses and bids from prospective vendors, and issue awards to vendors in a fully integrated and data-linked manner. A need also exists for a system that uses a commodity code or catalog to aid in the communication between and filtering of buying agencies and vendors, while enabling individual agencies to tailor the catalog to their own particular needs.

### SUMMARY OF THE INVENTION

The present invention is directed to an Internet-based commerce system simultaneously usable by multiple purchasing organizations and multiple vendors while controlled by a virtual single server and database. The commerce system is comprised of a firewall subsystem, a web server, a mail server, a database server, and central database. The commerce system handles the requisitions for commodities, including goods and services by system users and directs agency requisitions to other users for approval whether internal or external to that agency using approval routes previously established electronically within the central database. Requisitions are electronically processed into Requests for Quotation, Requests for Proposal, Requests for Information or Requests for Bid that are then released to the Internet for electronic responses by users representing vendors who access the system. Vendors with profiles matching the requests are actively notified of the requests preferably through response-prompting electronic mail. Using the system, users profiled by the system as buyers for the purchasing organizations process the electronic responses into awards. The system then notifies the awardees and makes available information about the awards to other vendors.

The system enables each purchasing organization to have its own unique electronic catalog of commodities to simplify and standardize the procurement process within the organization, while the system uses a basic catalog, preferably the NIGP commodities code, as a backbone for screening and communicating with vendors. Further, because the system operates with one virtual server and database, compilation and sharing of data that are stored on the system are possible. Vendor performance, user workload data can be compiled and shared within an agency or agencies using data search, compilation and representation software tools that known in the art. Similarly, users are preferably restricted, in accordance with user identifications used to access the commerce system, to a subset of data records in the database. The above and other objects, features and advantages will become apparent to those skilled in the art from the following description of the preferred embodiments.

### BRIEF DESCRIPTION OF THE DRAWINGS

FIG. 1 depicts a preferred embodiment of the basic hardware configuration for the Internet-based commerce system.

FIG. 2 depicts a preferred embodiment of the software module configuration for the Internet-based commerce system.

FIG. 3 depicts the basic routing within a procuring organization of an electronic requisition from the initial request to the release of the corresponding RFX (a pre-award document type) to the Internet.

FIG. 4 is a flowchart depicting a preferred software process for generating and communicating a Request Document record to a buyer.

FIG. 5 is a flowchart depicting a preferred software process for generating and releasing an RFX from a Request Document record.

FIG. 6 is a flowchart depicting two preferred software process methods of notifying vendors of released RFXs.

FIG. 7 is a flowchart depicting a preferred software process for enabling vendor responses to released RFXs and generating awards corresponding to the RFXs.

### DETAILED DESCRIPTION OF THE PREFERRED EMBODIMENTS

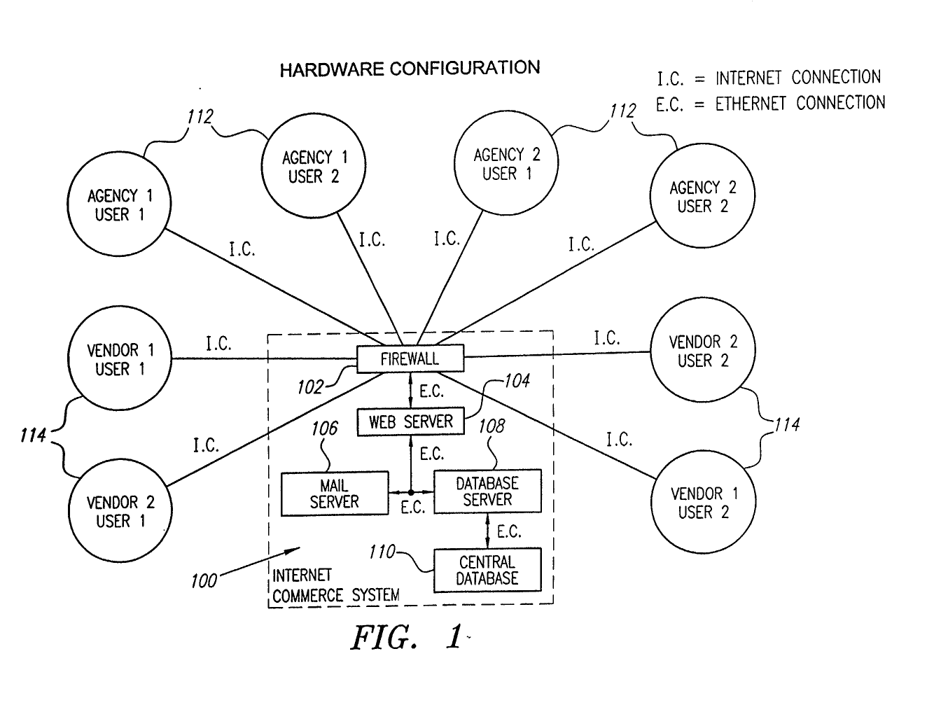

FIG. 1 depicts a preferred embodiment of the basic hardware configuration for the Internet-based commerce system 100. The commerce system 100 preferably comprises several subsystems including a firewall 102, a web server 104, mail server 106, database server 108, and central database 110. Preferably, each subsystem is a computer such as a Silicon Graphics™ Origin™ 200, Intel™ processor or other high-speed processing platform preferably having at least 500 megabytes of RAM and at least 25 Gigabytes of hard disk memory. Preferably, however, each subsystem is configured to allow for the connection of additional computer hardware to distribute the processing, memory, and bandwidth load as needed.

Functionally, the firewall 102 preferably polices the Internet communication with the commerce system 100. The system is preferably protected by a HTTPS 128-bit secure socket layer that essentially encrypts data that is transmitted over the Internet. Moreover, only users requesting system services over specified ports are handled by the commerce system 100. For example, HTML pages from users 112, 114 are served over a specific port address. Unless the port address for HTML pages is specified in the user's HTML communication, the user data is dumped by the firewall 102 preventing access to the rest of the commerce system 100. Similarly, File Transfer Protocol (FTP) communication is handled through another port. Again, the port must be specified in the FTP communication to enable access to the commerce system 100. Users from multiple agencies 112 and vendors 114 are handled by the commerce system 100 and share the central database 110. Specifically, the commerce system 100 will recognize a particular user, for example User 1, from a particular agency, for example Agency 1, or a particular vendor, for example Vendor 1. The number of users per agency, the number of users per vendor, the number of agencies and the number of vendors are all only limited by the system memory resources and the I/O bandwidth.

Communication internal to the commerce system 100 is preferably via Ethernet connection although another system communication protocol can be used. First, the firewall 102 is Ethernet-connected to the web server 104, which generally processes HTML pages into SQL instructions for the database server 108. The mail server 106 handles all e-mail communication and communicates with the database server 108 and web server 104 via an Ethernet connection. By having a mail server to handle much of the communication and data entry between users, I/O and computer processing bandwidth load is significantly reduced. Finally, the database server 108 handles all access to the central database 110, including processing the SQL statements from the web server 104 and instructions from the mail server 106. Optionally, the commerce system 100 additionally includes an Intranet server subsystem that features functions such as e-mail between users, calendars, chat rooms, message boards, task files, address books, and Intranet page publishing.

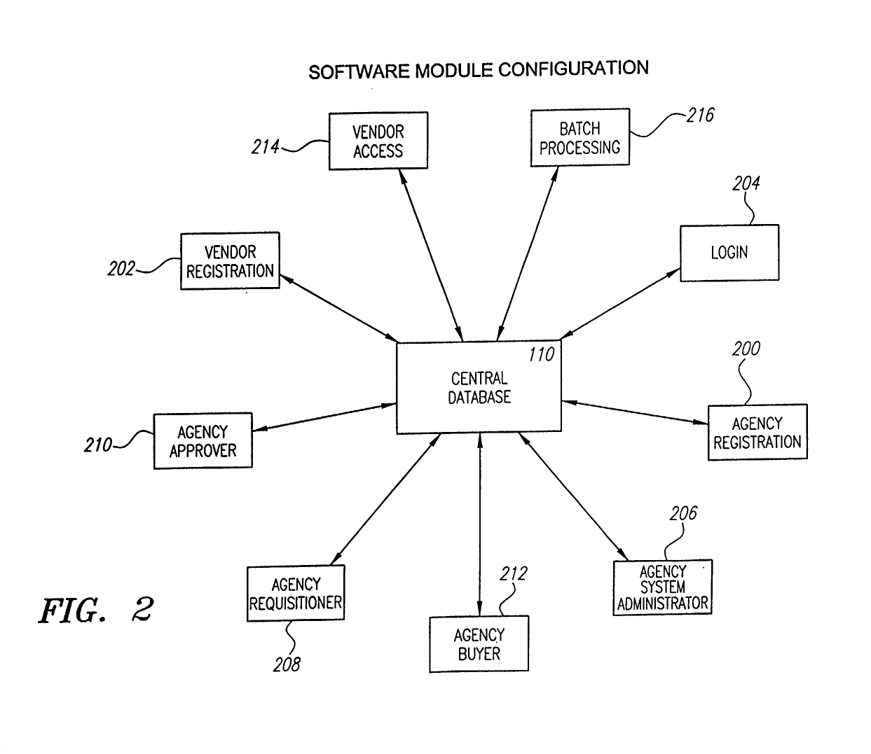

FIG. 2 depicts the preferred software modules and their configuration within the Internet commerce system 100. Preferably, each module performs a separate function that writes to or reads from the central database 110 as needed. The software system implementation includes an agency registration module 200, a vendor registration module 202, a login module 204, an agency system administrator module 206, an agency requisitioner module 208, an agency buyer module 210, an agency approver module 212, a vendor access module 214 and a batch module 216. First, the agency registration module 200 allows agencies to initially profile themselves to the commerce system 100, including identifying the system administrator for that agency. The agency registration module 200 further enables entry of general agency information including addresses and points of contact for the agency, billing, and revenue sharing. The vendor registration module 202 similarly allows vendor businesses to register themselves with the system and profile over the Internet the goods and services they supply. Optionally, the vendors can register to be on 24-hour call with respect to particular types of business opportunities. Further, the vendor registration module 202 preferably enables vendors to select specific agencies with which the vendors have a particular interest in doing business.

Also, when a previously registered vendor responds to a solicitation for a commodity that is not included in the profile record of commodities that the vendor supplies, then vendor registration module 202 preferably automatically adds the commodity to the vendor's profile. Alternatively, if the vendor is registered for a solicited commodity, but is not listed as a supplier with the soliciting agency, then the then vendor registration module 202 preferably automatically adds the specific agency to the vendor's profile record for that commodity. Preferably, the vendor is automatically via e-mail notified of the update to the vendor's profile record.

The login module 204 controls user access to system applications according to user ID. The login module 204 determines the identity of a user as the user logs into the commerce system 100 and then enables the particular applications, such as for example, the agency system administrator 206 module, agency requisitioner module 208, or agency buyer module 212, that the user is authorized to access. Finally, the login function 204 accesses the database 110 to identify the active records that indicate the user's ID in one or more of its fields and then provides a summary of that data to the user in an information window. In this way, the user views its current workload related to the processing of requests of goods or services.

The agency system administrator module 206 is an application module that enables a particular agency user, called an agency system administrator, to establish and control all parameters associated with a given agency. Specifically, the agency system administrator module 206 enables the agency system administrator to enter or modify agency information, establish accounting structures, and populate and manage detailed commodity groups particular to the agency using the NIGP code or another commodity catalog as a platform. The system administrator can also enter data regarding agency delivery points, local area business preferences, miscellaneous agency-wide default values and any general requirements or instructions for documents originating from the agency.

The agency system administrator module 206 further allows the agency system administrator to establish users within the agency and associate users with particular applications, functions, and abilities. Specifically, the system administrator can create agency departments including department administrators and users. The system administrator further establishes approval workflow maps for individual users. An approval workflow map for a user designates other users to whom work completed by the user is made available.

Preferably, the agency system administrator module 206 also allows the agency system administrator to execute report inquiries to the database 110. Various types of reports are thereby generated. The reports that may be generated preferably include requisition-to-purchasing purchasing cycle time reports, purchasing cycle time reports, history of award reports, and vendor listing reports that are variable according to variations in listing criteria.

The agency requisitioner, agency approver, agency buyer, and vendor access modules 208, 210, 212, 214 are applications made available to users by the commerce system 100 depending on the individual configurations established by the system administrator. The agency requisitioner module 208 enables the user to produce and transmit a request for the purchase of particular goods and services. The agency approver module 210 is a mechanism for approving electronic agency documents. The agency approver module 210 preferably provides for the option of having at least five levels of approvals before an electronic requisition is forwarded to a buyer. The agency buyer module 212 is an application generally made available only to buyers. The agency buyer module 212 enables users configured with buyer capabilities to convert electronic requisition documents into pre-award document types, called RFXs, for the goods the buyer is assigned to buy. These RFXs include Requests for Proposal (RFPs), Requests for Bid (RFBs), Requests for Information (RFIs) and Requests for Quotation (RFQs). The agency buyer module 212 further enables buyers to release RFXs to the Internet. Also, the vendor access module 214 enables users representing vendors to access the commerce system 100 and view awards that have been made, business opportunities in the form of RFXs that have been released, and subsets thereof based on search criteria selected by the vendor. While vendors generally only use the vendor access module 214, vendors may optionally use the modules used by procurement organizations and thereby conduct business on the commerce system as both a buyer and a vendor. By enabling the combination of tools by a single business entity, the commerce system 100 enables vendor-to-vendor transactions. Preferably, the combination of tools is also used by non-profit organizations (NPOs) to further enable NPO-to-business and NPO-to-agency transactions. Finally, preferably, vendors can request additions to the basic five-digit commodity code index used by the commerce system 100.

With respect to vendors in the construction business, the vendor access module 214 enables vendors who are general contractors to download construction plans developed for a public agency, such as those stored in a city plan holder's room. Additionally, registered vendors who are construction subcontractors receive an e-mail notification from the commerce system's mail server 106 for each general contractor that downloads an agency's construction plans. The commerce system 100 thereby facilitates construction business communication between agency and general contractor and between general contractor and subcontractor.

The batch module 216 preferably executes at a particular time each night, processing the active records for all agencies that are registered on the commerce system 100. A change in a record's status based on the previous day's work typically will cause the batch module 216 to act on the record in some manner. For instance, the batch module 216 will change the status of RFX records that were previously released to the Internet but that are scheduled to be closed to bidding by the current date. Further, the batch module 216 initiates the e-mail to appropriate vendors of RFXs that are presently to be released to the Internet. A vendor who receives an e-mail of an RFX is filtered by the batch module 216 according to its registration status and the selected commodity codes and agencies in the vendor's profile.

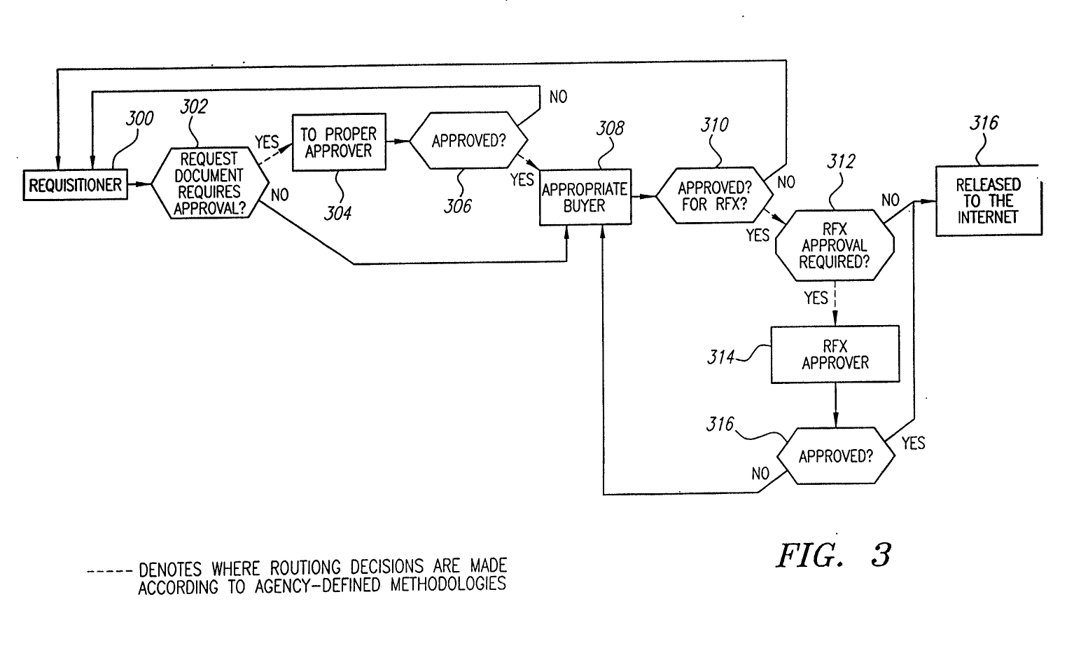

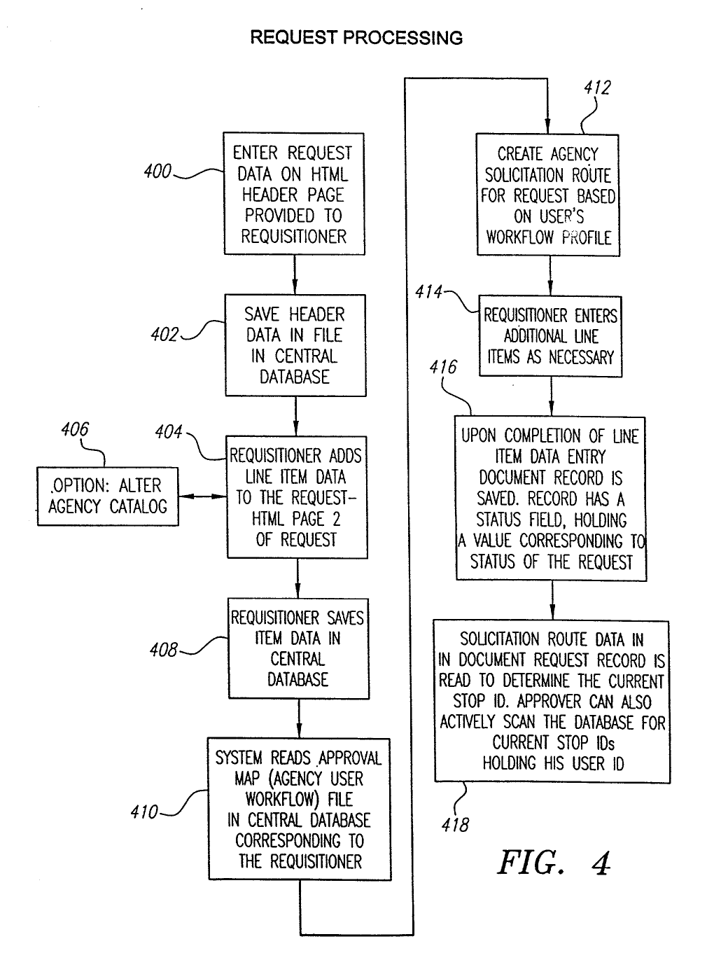

FIG. 3 depicts an overview of one possible route for a request from the original requisitioner through the chain of users within an agency that must approve the request before its release to the Internet. The process begins with the creation of a Request Document record by a by a user within the agency or requisitioner 300, and then its transfer to a proper approver if an approval of the requisition is required as shown by the Require Approval branching step 302. The system's software processing of these first steps are detailed in FIG. 4. As shown in FIG. 4, a requisitioner first enters request document data on an HTML header page that has been provided to the user/requisitioner 400. The software enabling the entry of request document data is part of the agency requisitioner module 208. The request document header data for entry preferably includes a reference number for the request document and a confirming number to enable a rush of the request through the approval process including preferably, a direct e-mail to appropriate approvers in the approval route and the provision for an emergency purchase order number. The header data may also include delivery date(s), delivery point(s), alternate delivery point(s), contact persons, and specific header notes. Preferably, if the requisitioner 300 specifies a nonstandard delivery point, the system automatically detects the condition. Because the existence of a standard delivery point is preferably previously specified in the setup for the procuring organization by the system administrator, a requisitioner's data entry of a nonstandard delivery point results in an automatic notification e-mail to the procuring organization's system administrator. Finally, when the request document header page is completed, the header data is saved in a file in the central database 402.

In a preferred embodiment, the commerce system 100 provides each agency the option using system-assigned reference numbers for documents or retaining an agency's indigenous numbering system. The commerce system 100 allows an agency to retain its own document numbering system by performing translations to and from the system's internal indexing scheme. For example, where an agency's designation for the first RFQ of the year 1999 may be “RFQ990001,” the system will in real-time translate such entered document designations into its own index, such as “Q1999000001.” The system also necessarily provides for reverse translation of document designations such as when a user seeks to have displayed a set of document numbers that are result of a specific search. Preferably, the system 100 supports separate translation routines for each agency that chooses to retain its own document numbering scheme.

The requisitioner 300 is then prompted to complete a second HTML page of line-item data for the request 404 relating to the goods to be included in the request document record. In this step 404, the commerce system 100 allows for date entry of the specific goods to be requested. To select the goods, the requisitioner 300 accesses an electronic catalog of goods organized according to a three-digit class, two-digit item, two-digit group and a three-digit detail. The class and item values preferably correspond to the standard NIGP code of goods and services. The group and detail digits correspond to specific details regarding the goods that are commonly requested by that particular agency. Thus, each agency on the commerce system 100 internally possesses its own tailored catalog of specific goods and services that it commonly requisitions. However, because each tailored commodities catalog exists on a single database 110, the commerce system 100 preferably allows agencies to merge their tailored NIGP codes, enabling a greater level of standardization while maintaining the details in the communication between procuring agencies and vendors.

In practice, the generation and use of a tailored commodities catalog preferably involves all users within a procurement organization. For example, for a request of a box of yellow 8 ½″ by 11″ bond paper for a requisitioner's department, the requisitioner 300 will first scan the basic five-digit NIGP code for paper. However, within this basic code, the commerce system 100 will have specified various kinds of paper (i.e. yellow 8½″ by 11″ bond) that that the agency has requested in the past. For goods that are first requested, the agency, through the functionality of the agency system administrator module 206, will have specified group and detail indices concatenated to the basic NIGP code that correspond to this specific kind of paper. Over time, group and detail indices for various kinds of paper that have been requested will be specified, resulting in a highly tailored NIGP-based catalog that is unique for each agency on the commerce system 100. Thus, as the requisitioner 300 is specifying the goods to be requested, the requisitioner 300 first scans his agency's tailored commodities catalog to determine if the specific goods in question are already in the catalog. If so, the requisitioner 300 can select those goods for requisition and then proceed to enter other data. If the desired goods are not in the catalog, the requisitioner 300 preferably has the option of requesting an addition to the catalog. Alternatively, the requisitioner can directly make additions to the agency's commodity catalog 406.

On the second HTML page of the request, the requisitioner 300 enters other line item data including the quantity of the goods. Optionally, the requisitioner 300 enters the units of measure for the goods, whether it is a fixed asset, any purpose restrictions, a file attachment, line item notes, and any allowable variance in quantity. Preferably, the request allows for the entry of a specific fund from which the payment for the cost of the commodity is drawn. The request alternatively preferably allows for the entry of multiple funds to enable cost sharing between funds for particular commodities. Allocation between funds is preferably enabled according to percentage of cost, by dollar amount or by quantity. Funds are preferably specified by entry of fund-specifying information in data fields indicating the organization, the account, the task, the subtask, the option and/or the activity.

After the requisitioner 300 completes data entry or at any other time during the generation of the request, the requisitioner 300 preferably may edit or review the header page, the commodity description, or any other field. Once the data on the request pages has been entered, the requisitioner 300 preferably saves the line item data in the central database 110, 408. The combined header and line item data form a single request document record in the central database 110.

In the next step, the commerce system 100 scans the approval routing map that is unique to the requisitioner 300 that originates the request document record 410. The approval map, called an Agency User Workflow record, is previously generated by the system administrator and stored in the central database 110. The approval map defines the route of users that the request document record must take before a buyer for the procuring organization reviews the request document. The particular approval route for a request document record is preferably defined by the requisitioner's position within the organization, the commodity or commodities requested, the amount requested and the price. Any one or all of these variables can affect the approval route.

Preferably, the particular approval route is also defined by any alternate users that have been specified to act in place of one or more available approvers. More generally, the commerce system 100 allows alternate users to be specified when the usual user for a particular task is absent, unavailable, on vacation, etc. In such circumstances, the system enables establishing pseudo accounts to give an alternate user the rights it requires to perform as an alternate user. Moreover, if the usual user possesses multiple capabilities, for example, rights to initiate requisitions, act as a buyer, and act as a requisition approver, then the system 100 enables different alternate users to be specified for each of the rights. Further, when the usual user returns or is again available, the system 100 preferably resets the rights, status and capabilities to the usual user.

From the Agency User Workflow profile defined in the commerce system 100 for the requisitioner 300 and the parameters values specified in the particular request document record, the commerce system 100 generates an Agency Solicitation Route record 412 that becomes part of the request document record. Thus, inherent in the requisition process of the commerce system 100 is effectively an electronic audit trail. Preferably, every significant act by a user in the process of completing, approving, responding to or awarding a requisition is stored in the commerce system 100. Thus, the responsible parties involved in any procurement are readily determined. Next, if the requisitioner 300 desires to request additional goods as part of the same document request record, line item data for such additional goods may be entered 414 on subsequent line item HTML pages. When all goods have been entered into the document request record, the commerce system 100 saves the final document request record in the central database 110, 416. The record includes a Status field that holds a value corresponding to the status of the request. Once the data is saved, a Current Stop ID field in the Agency Solicitation Route designates the user in the agency that must approve the request. Normally, the approver is made aware of the request by actively performing a database scan of requests within the agency that require that approver's approval. The database server scans the Current Stop ID in all of the agency's requests and lists those requests for the approver 418.

The approver can similarly be made aware that a new document request record has been created that requires his approval when the approver first logs into the commerce system 100 with his user ID. As mentioned above, the login module summarizes a user's workload as the user logs into the commerce system 100. The data in the information window provided to the user upon login preferably includes the following numerical summary regarding request documents involving the user:

# of request documents in the approval-processing phase

# of request documents requisitions

# of request documents awaiting an action by a buyer

# of request documents viewable on the Internet

# of request documents awaiting an award from a buyer

# of request documents placed on hold by a buyer

# of request documents being worked on by a buyer

# of request documents in a buyer's approval flow

# of request documents in which an award was made but further approval is required before a purchase order is issued

# of request documents that were disapproved by a buyer's approver

# of request documents awarded

As the data in the information window changes, the user is informed of the progress of work that he is involved in as well as new work that must be handled. The user can then examine the particular records requiring his attention.

Referring again to FIG. 3, the transmission of a requisition to a proper approver 304 effectively takes place with the modification by the system of the Current Stop ID field in the request document record as each approval is made. Depending the on the approval chain or Agency User Workflow for the request document record, the request document record for a request may have one or more changes to its Current Stop ID field as approvals to the request are authorized. When a proper approver reviews the data in the request document record, the approver must decide whether to approve or disapprove the request 306. As each approval is authorized, the Current Stop ID field is modified to have the user ID of the next approver. If all approvals in the request approval route are given, the system will modify the Current Stop ID field in the request document record to that of a buyer in the requisitioner's solicitation route and corresponding to the goods and/or services specified in the request.

If the request document is disapproved, the Current Stop ID field is modified to the user ID of the original requisitioner 300. Notes or comments from the approver who disapproved the request document may also be saved as part of the request document record for review by the original requisitioner 300. Thus, when the original requisitioner 300 instructs the system to scan for request document records (that is, the Current Stop ID fields of those records) with his user ID, the requisitioner 300 will see the disapproved request document records with the comments from the approver in his approval route that disapproved the request. In the approval route shown in FIG. 3, only one approval is required before the request is made available to the appropriate buyer 308 specified in the solicitation route for the request. If no approval is required for a request document record generated by a requisitioner 300, the request document record proceeds directly to the appropriate buyer 308.

Like any other user, the appropriate buyer 308 for the request document record is made aware of the request document record when the buyer 308 actively instructs the system to scan the database 110 for approved request document records having that buyer's user ID in the Current Stop ID field and/or through the workload summary process performed by the login module 204. The approval process from the time that the approved request document record reaches the buyer 308 until the request document record is released to the Internet is similar to the method of processing the original request document record into an approved request document record that is viewed by a buyer.

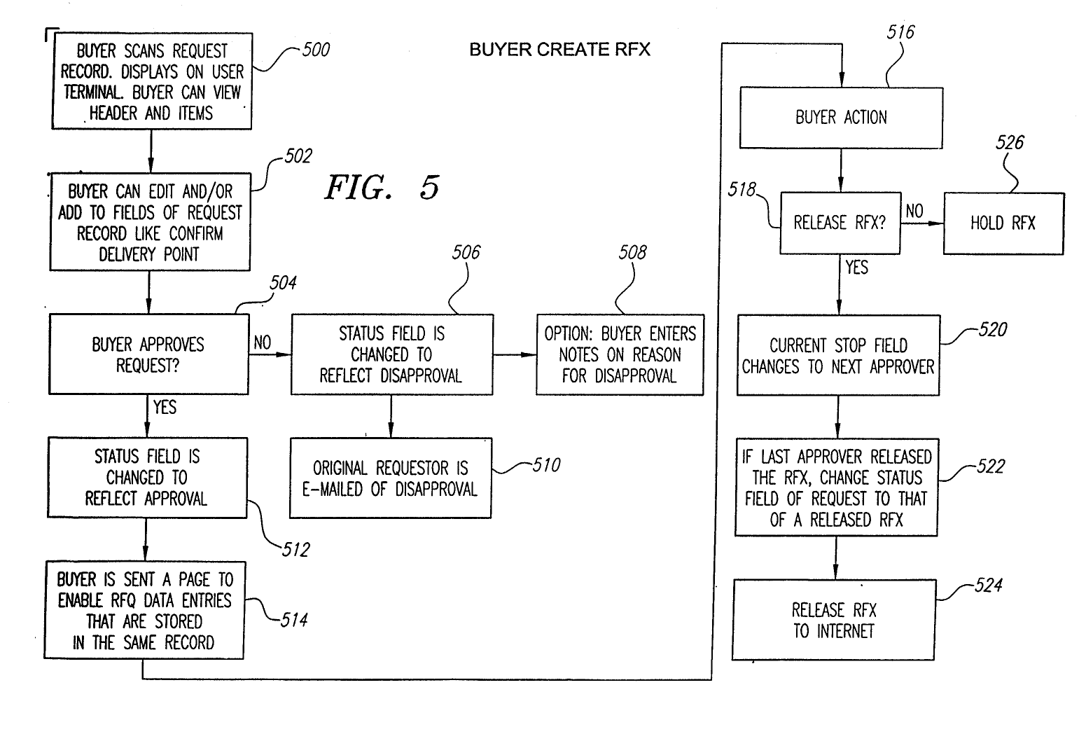

FIG. 5 details the steps in converting an approved request document record into an RFQ, RFI, RFB, or RFP record that is released into the Internet. First, as noted above, the buyer 308 is notified of or may actively scan for approved request document records having his user ID. Preferably, multiple methods of workload distribution are provided by the system to enable the designation of document records to various buyers. The system preferably may automatically select buyers based on the NIGP code of the commodities requisitioned. Further, the system may enable a pool of document records to be established from which buyers select items to process. As another alternative, the document records are initially assigned to a supervising buyer who then assigns items to other subordinate buyers. In each of these methods, the Current Stop ID is simply changes to reflect the current disposition of the document record.

Approved request document records are distinguished from request document records awaiting approval by a separate field in the request document record called a Status field. The commerce system 100 scans for Status fields with a value corresponding to an approved request document record and having a Current Stop ID with a particular buyer's user ID. The system then provides the buyer 308 with the details of the approved request document record to the buyer 308 on the buyer's terminal. At this time, the header and line item data entered by the original requisitioner 300 are viewable by the buyer 308, 500. Furthermore, the buyer 308 can view, edit and/or add to the fields of the approved requisition record, such as confirming or changing the delivery point for one or more of the line items of goods included in the requisition 502.

When the buyer 308 has completed his modifications to the approved request document record, the buyer 308 then chooses whether to approve for RFX 310 the approved request document record and thereby create an RFX, or to disapprove the requisition 504, returning the requisition to the original requisitioner 300, 510. As shown in FIGS. 3 and 5, if the request document record is disapproved buy the buyer 308, the request document record is routed back to the original requisitioner 300, 510. The Current Stop ID field is changed to the user ID of the original requisitioner 300, and the Status field preferably becomes that of a request document disapproved by a buyer 308, 506. Optionally, the buyer 308 may enter notes on the reasons for disapproval 508. The system saves these notes as a separate data file that is linked to the request document record by the document reference number for that record. While the original requisitioner 300 may actively scan the system for buyerdisapproved request document records, preferably the system automatically e-mails the requisitioner 300 of the disapproval.

If the buyer 308 approves the request document, the commerce system 100 changes the Status field for the request document record into that of an RFX in progress 512. The system then sends an electronic page for the entry of RFX data to be stored in the same record 514. On this page, the buyer 308 can confirm or add a reference number for the RFX, select the response type (RFP, RFB, RFI, or RFQ) for all or selected line items, select the closing date for the receipt of vendor responses, and select or confirm the delivery date for each line item. Optionally, the buyer can edit or enter the freight pay type, confirm the delivery point, modify the source of finds for payment, add new instructions for the vendors regarding the request, or add record header notes. Additional instructions and header notes are preferably saved as a separate file, and are preferably linked to the new RFX document record by the document reference number, the requisition number, and detail and item numbers. The RFX page preferably is then saved as part of the original request document record that was created with the original requisitioner 300.

At this stage, the Status field is again modified depending on the action selected by the buyer 516. Optionally, the RFX can be approved for RFX 310 by the buyer 308. In this case, the Status field is changed from an RFX in progress to a value representing a buyerreleased RFX 518. As shown in FIG. 3, a release of the RFX by a buyer 308 may or may not indicate that the RFX is released to the Internet. If the buyer's decision requires the RFX approval 312 of an RFX approver 314, the status of the RFX may simply be changed to that of an RFX in Approval and correspondingly, the Current Stop ID will be changed to the appropriate RFX approver 314, 520 in that buyer's previously established approval map. If the buyer's decisions require no further approval, the Status field for the RFX is changed to that of an Internet-released RFX 316, 522. The RFX approver then preferably has the same choice of options 318 as the buyer 308, that is, releasing, holding or disapproving of the RFX. In each case, the Status field is changed accordingly. In FIG. 3, only one RFX approver 314 is necessary before the RFX is released to the Internet 316, 524. On the other hand, an RFX could require additional RFX approvers 314, if an agency's system administrator chooses to so configure the buyer's approval map in that manner. However, once the last RFX approver in the approval route for an RFX releases the RFX, the system changes the Status field for the RFX to that of a Released RFX. A Released RFX represents a Status field that vendors on the Internet can view.

The buyer 308, alternatively, also has the option of placing the RFX on hold 526, a situation that would be acted upon by the system by changing the Status field value for the RFX record. One advantage of enabling the buyer 308 to place an RFX record on hold is that it provides the foundation for enabling the buyer 308 to merge different RFX records that may include the same goods or category of goods. By placing an RFX on hold, a table is preferably generated of such held RFXs and is preferably organized according to the NIGP code(s) and/or the release date specified in the RFX. Preferably, if the buyer desires to merge an RFX with others making similar requests, the system generates a new RFX record that encompasses the items in the held RFX records that have been merged together. The new merged RFX, having fields that reference the RFXs that it comprises, is then later released by the buyer 308 to the Internet. By having this capability, discounts for larger volumes of goods may become available that might not otherwise be available if RFXs were individually released. Preferably, because multiple procuring agencies are using the same central database 110, RFXs from different procuring organizations can pool RFXs with similar requests and potentially obtain greater discounts than could be obtained otherwise if the agencies conducted their procurement of goods and services independently.

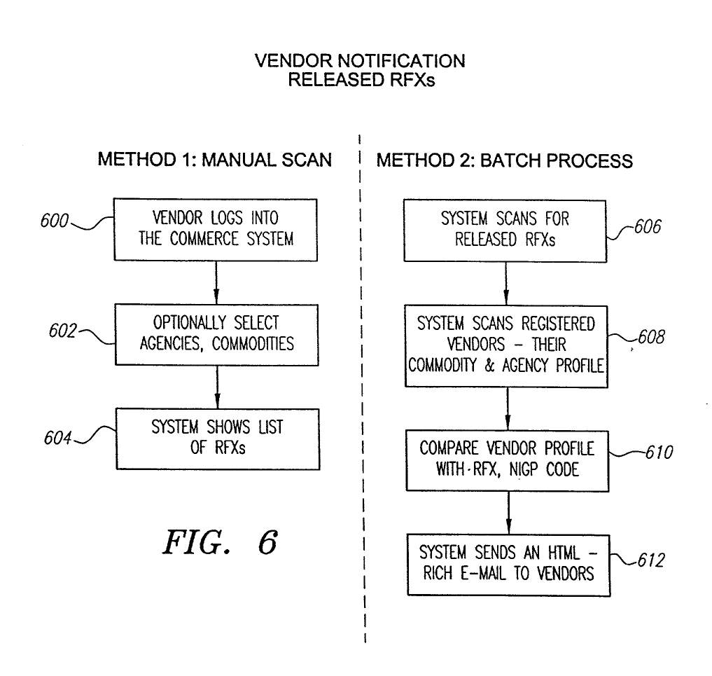

FIG. 6 depicts two alternative methods by which vendors using the commerce system are notified of RFXs that agencies have released. By a first method, a vendor first logs into the commerce system 600. As released RFXs that have not been closed to bidding have a particular Status field value, such RFXs are viewable by vendors who wish to examine the database. Optionally, vendors can perform specific searches within the set of RFXs by filtering the set according to particular agencies, commodities, etc. 602. By applying various kinds of filtering to the set of viewable RFXs, vendors can view a subset of RFXs 604 that pertain to the vendors' particular interests.

According to another method of enabling vendors to become notified of relevant RFXs, the commerce system 100 automatically performs vendor notification preferably using a daily batch process performed by the batch module 216 discussed above. In this method, the commerce system 100 scans the database 1 10 for just Released RFXs 606, that is, document records corresponding to a particular Status field value. The system also scans for vendors that have registered themselves in the database 10 with a particular profile of agencies for which those vendors have a business interest and commodities, preferably based on the five-digit NIGP code (but without the additional five-digit tailoring developed by the procuring agencies) 608. The system then filters the set of vendors according to their profiles and the basic NIGP code specified in the RFXs to determine the subset of vendors that will receive a notification regarding a particular RFX 610. The buyers for the procuring agencies cannot exclude or include particular vendors from receiving the notification. Thus, each just-released RFX has its subset of vendors that receive a notification. The commerce system 100 then sends an HTML-rich e-mail to the determined subset of vendors 612, enabling a prompt and data-specific response from the vendors.

Preferably, the system 100 allows buyers to amend the RFXs after their release to the Internet. To effectively amend an RFX, the system 100 automatically transmits e-mail to all vendors that received the original RFX. Preferably, registered vendors receive the amendment, which includes the updated and complete RFX and a section indicating the reasons for the amendment including the changes from the original RFX. With respect to non-registered vendors, the system 100 identifies and records in a download tracking file those vendors that previously accessed the original RFX. Preferably, these non-registered vendors are notified by e-mail that an amendment has been made. More generally, agency buyers may access, for status and other reasons, the data in the download-tracking file on vendors (registered and non-registered) that have downloaded released RFXs.

The system also provides buyers with the ability to communicate with vendors directly according to desired groupings. Buyers may e-mail vendors according to a particular solicitation that selected vendors received, by registered commodity, by type of vendor, by vendor in a particular city, state or zip code, and/or any other criteria that distinguishes vendors from each other. Alternatively, the system allows buyer and others to create and define customized groupings of vendors and others. Such groupings may be established for purposes of solicitation, communication, comparative analysis, etc.

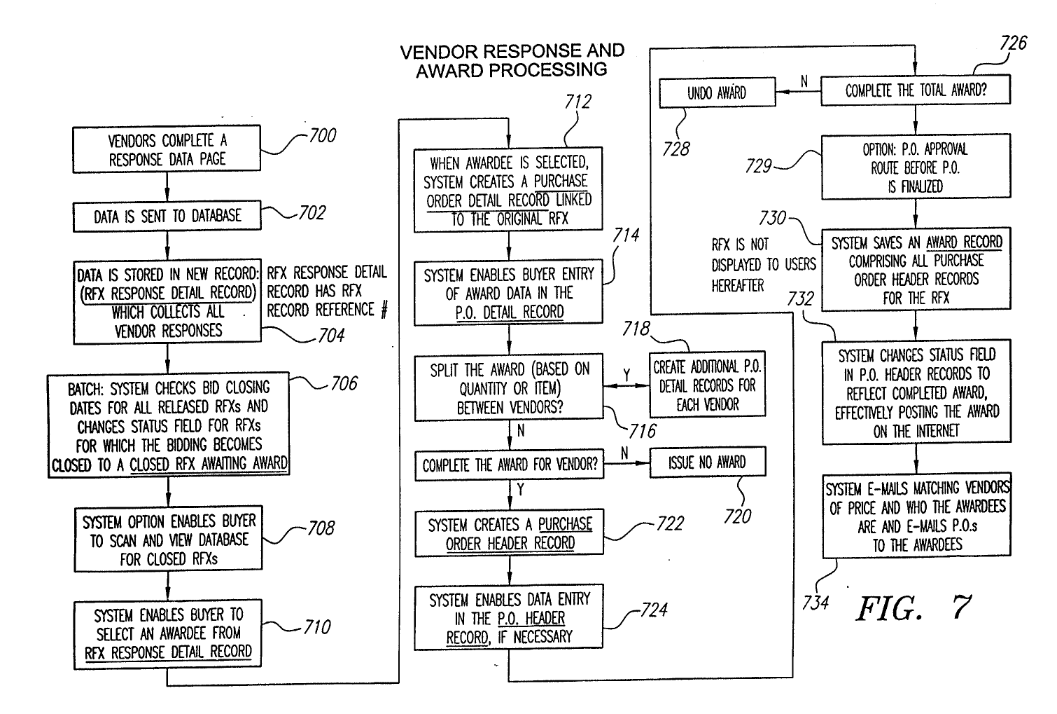

FIG. 7 depicts the process by which vendors respond to a notification of an RFX according to the batch processing 216 discussed above and by which an award is issued by the procuring organization. First, with the receipt of the e-mail notification, the vendor completes a response data page 700. Preferably, this page prompts the vendor to enter a price for the goods or services requested and any comment that the vendor desires to include regarding any desired transaction terms. Once the response page is completed, the vendor can submit the data as its bid. Moreover, each time that the vendor logs into the system, the system scans the vendor's RFX response file and enables the vendor to modify or remove any bids it has submitted. The commerce system transmits the data to the central database 702. By requiring responses in this manner, the commerce system 100 implements a blind bidding system that vendors normally must adhere to in dealing with public agencies. The vendor response data is then stored in an RFX Response Detail record, which collects all of the vendor responses 704. This new record is linked with the original RFX record by the original RFX record reference number. This record will continue to store vendor responses until the bidding closing date specified in the original RFX record. This function is performed as part of the batch process 216. The batch process 216 scans the bid closing dates for all of the commerce system's released RFXs, and then changes the Status field value for such released RFXs when the time for bidding becomes closed 706. By changing the Status field value, a released RFX record becomes a Closed RFX Awaiting Award.

Optionally, the buyer for the RFX can scan the database for RFX record Status fields with values corresponding to a closed RFX 708. Software tools associated with the Agency Buyer module 212 enable the buyer to have the commerce system scan and list, on a line item basis, the RFXs that await award. The buyer can then select an RFX to examine. The buyer can then scan the finalized RFX Response Detail Record corresponding to a particular RFX record. The buyer has the option of viewing the vendor responses, including vendor line item instructions and comments, scanning the database for the award history corresponding to a particular vendor that responded, and sending a personalized e-mail to a vendor contact. The buyer preferably can list the vendors according to different aspects of their responses including the price quoted per unit of measure for the goods.

After the buyer reviews the vendor responses and optionally, any data on the vendors compiled in the database 110 that the buyer chooses to examine, the system enables the buyer to electronically select an awardee from the vendors listed in the RFX Response Detail Record 710. The award can be limited to a particular line item of goods or simply a portion of the total quantity for an item on the RFX. When the buyer selects an awardee, the commerce system 100 creates a Purchase Order (P.O.) Detail Record that is linked by reference number to the original RFX record 712. With the creation of this record, the commerce system 100 sends the buyer an award data entry page, the entered data to be stored in this new record. Preferably, the buyer can enter various kinds of information regarding the award including whether the item to be procured is taxable or not, and if it is taxable, the buyer may specify the appropriate tax rate. The buyer preferably can also attach a file and may add comments that are internal to the agency. For example, if the buyer selected a vendor that did not have the lowest bid, the system preferably requires a statement regarding the buyer's decision that is stored in the system. In this way, the commerce system polices against favoritism by individuals within a procuring organization for certain vendors.

The commerce system 100 also enables the buyer to add new instructions regarding the line item of goods or all the goods. If the award for a particular vendor does not cover all of the goods in the RFX, then the commerce system enables the buyer to split the award between different vendors based on quantity or item 716. Under those circumstances, additional P.O. Detail records are created by the system for each vendor 718. A P.O. Detail record is created for each new vendor that is awarded a portion of the set of goods listed in the RFX.

Once a P.O. Detail record is completed for a vendor the system preferably enables a buyer to undo the award 720 or save the award. Although the buyer can return to create additional awards for additional vendors based on the same RFX, once the data entry for a first awardee is completed, the system creates a P.O. Header record 722. This header record concerns data that is general to the award to a particular vendor. Thus, the system sends the buyer an additional page for award data entry in the P.O. Header Record, if necessary 724. The data that the buyer enters preferably includes a lag time for the release of the award and/or purchase order, an award type, such as for example, whether the delivery is definite or indefinite, and comments regarding the basis of the award. The buyer can preferably enter the type of competition, that is, whether it was open, limited or sole source, notes on why a non-low bid was awarded, general P.O. comments, other notes for internal personnel, and who will be the signatory for the purchase order. The buyer may also optionally attach a file to the P.O. Header Record. Also, at any time, the buyer can save the data and return later to the record or cancel the data entries entirely.

Once the P.O. Header record is completed for an RFX, the system preferably enables the buyer to complete the total award 726 or undo the award 728. If the buyer chooses to complete the award, the commerce system preferably saves the data in a new record called an Award record 730. Optionally, the system may provide for a purchase order approval route 729 similar to the approval route required for a request document or an RFX as shown in FIG. 3. However, once the award is completed, the original RFX record is preferably no longer viewable by the vendors on the system, as the processing by the commerce system of the original RFX becomes complete. The Award record holds all of the P.O. Header records pertaining to the original RFX. Furthermore, the commerce system 100 modifies the Status field in each of the P.O. Header records from an award in progress to a completed award 732. By doing so, access by vendors to the terms of the completed award is enabled. By so changing the Status field, the completed award is effectively posted in the Internet for viewing by all vendors on the commerce system 100. Finally, the commerce system preferably e-mails the P.O.s to the awardees and e-mails interested vendors about the award, including the identity of the awardees and the accepted price 734. The commerce system 100 preferably provides the capability for a hard copy of the purchase order to be printed and delivered to the awardees, if necessary.

Once the procuring agency receives the goods from the vendors, the commerce system 100 provides the capability of entering data in the P.O. Header record regarding vendor performance in its delivery of the goods, the quality of the goods or services, etc. Over time, historical data on vendor performance in dealing with a particular procuring agency is generated. This data can be compiled and used as a decision tool when new awards are considered. Under certain circumstances, vendor performance data across multiple procuring agencies can be compiled and shared by procuring agencies. The advantage of such sharing of data is that perhaps a clearer picture of a vendor's overall performance is produced.

Although the invention has been described with reference to preferred embodiments, it will be readily appreciated by those of ordinary skill in the art that many modifications and adaptations of the invention are possible without departure from the spirit and scope of the invention.

What is claimed is:

1. A system for generating a request for a commodity for processing by a buyer, the system comprising:
(a) a requester terminal for inputting request data relating to the request;
(b) a memory for storing an approval route map comprising data fields specifying potential buyers for processing the request;
(c) a processor for accessing the request data and the approval route map and for identifying therefrom the buyer to process the request;
(d) a buyer terminal for receiving the request data; and
(e) a communication link providing communication between the processor, the requester terminal and the buyer terminal.

2. The system of claim 1, the approval route map being specific to the requester.

3. The system of claim 1, the request data including a commodity type for the commodity requested, and the processor using the commodity type to at least in part identify the buyer processing the request.

4. The system of claim 1, the request data including a quantity value for the commodity requested, and the processor using the quantity value to identify the buyer processing the request.

5. The system of claim 1, the request data including a price for the commodity requested, and the processor using the price to identify the buyer processing the request.

6. A method of requesting a commodity through a buyer comprising the steps of:
(a) inputting request data relating to a request regarding the commodity;
(b) electronically determining the identity of the buyer using the request data and an approval route map; and
(c) electronically notifying the buyer about the request.

7. The method of claim 6 further comprising a step between step (c) and (d) of:
(c1) notifying an approver of the request according to an approval route map in the server; and
(c2) notifying a requester of a decision on the request when the approver acts on the request.

8. The method of claim 6, the request data comprising header information and information relating to the commodity.

9. The method of claim 6, the request data including a commodity type for the commodity requested, and the identity of the buyer processing the request being determined in part by using the commodity type.

10. The method of claim 6, the request data including a quantity value for a commodity requested, and the identity of the buyer processing the request being determined in part by using the quantity value.

11. The method of claim 6, the request data including a price for the commodity requested, and the identity of the buyer processing the request being determined in part by using the price.

12. A system for processing requests for a commodity into an RFX for viewing by one or more vendors, the system comprising:
(a) a memory for storing a request as request data in procurement data fields;
(b) a processor for modifying the request data in a procurement status field of the procurement data fields to reflect a status of the request;
(c) a buyer terminal for inputting RFX data regarding the RFX in RFX fields of the procurement data fields;
(d) a vendor terminal representing at least one vendor for outputting the RFX data; and
(e) a network electronically linking the processor, the buyer terminal, and the at least one vendor terminal for releasing the RFX data to the at least one vendor terminal.

13. The system of claim 12, the processor modifying the request data in a current handler field of the procurement data fields according to an approval route map in the memory to reflect an approval status of the RFX.

14. The system of claim 12, the processor providing notification if the commodity specified in the request is in a class shared by a commodity specified in other requests that await being released to the network.

15. The system of claim 14, the processor providing notification if the request specifies a quantity of the commodity that, in sum with quantities specified in the other requests, exceeds a predetermined threshold quantity level.

16. The system of claim 12, the processor providing notification if the request specifies a quantity of the commodity that exceeds a predetermined threshold quantity level when the quantity is summed with quantities specified in other requests that further specify a commodity in a class shared by the commodity specified in the request and that await being released to the network.

17. A method of processing requests for a commodity into an RFX for viewing by one or more vendors, the method comprising the steps of:
(a) providing a request as request data in procurement data fields of a processor-accessible memory;
(b) automatically modifying the request data in a procurement status field of the procurement data fields to reflect approval of the request;
(c) inputting RFX data regarding the RFX in RFX fields of the procurement data fields;
(d) releasing the RFX data to an electronic network accessible to the one or more vendors; and
(e) modifying the procurement status field to reflect the release of the RFX data to the network.

18. The method of claim 17 further comprising steps between steps (c) and (d) of:
(c1) automatically notifying an approver concerning the RFX according to an approval route map; and
(c2) automatically notifying a buyer concerning a decision on the RFX when the approver acts on the RFX.

19. The method of claim 17 further comprising a step of automatically providing notification if the commodity specified in the request is in a class shared by commodities specified in other requests that await being released to the network.

20. The method of claim 19 further comprising a step of automatically providing notification if the request specifies a quantity that, in sum with quantities specified in the other requests, exceeds a predetermined threshold quantity level.

21. The method of claim 17 further comprising a step of automatically providing notification if the request specifies a quantity of the commodity that exceeds a predetermined threshold quantity level when the quantity is summed with quantities specified in other requests that further specify commodities in a class shared by the commodity specified in the request and that await being released to the network.

22. The method of claim 17 further comprising a step of notifying a requestor of a decision on the request if a buyer acts on the request.

23. A system for enabling the generation of a procurement award from a released RFX to a vendor of commodities to receive the procurement award, the system comprising:
(a) at least one vendor terminal for submitting bids on the released RFX;
(b) a buyer terminal for collecting bids to the released RFX from at least one potential vendor, selecting the vendor to receive the procurement award from among the at least one potential vendor, and entering purchase order data;
(c) a processor for modifying RFX data in an RFX status field of an RFX data record to reflect when bidding on the RFX is closed and when the procurement award is issued; and
(d) a memory for storing purchase order data in a purchase order record linked to the RFX data record.

24. The system of claim 23, the processor requiring an input of a comment regarding the award when the vendor to receive the procurement award does not have a bid that is lowest of the collected bids.

25. The system of claim 23, the processor notifying the at least one potential vendor of the issuance of the award, including the identity of the vendor to receive the procurement award and the purchase order data.

26. A method of enabling the generation of a procurement award from a released RFX to a vendor of a commodity to receive the procurement award, the method comprising the steps of:
(a) electronically collecting bids to the released RFX from at least one potential vendor;
(b) modifying RFX data in an RFX status field of an RFX data record at a vendor bid closing time for the RFX to reflect that the RFX is closed;
(c) electronically selecting the vendor from among the at least one potential vendor to receive the procurement award;
(d) entering purchase order data into a purchase order record linked to the RFX data record; and
(e) modifying the RFX status field to reflect issuance of the award to the vendor.

27. The method of claim 26 further comprising the step of automatically requiring an input of a comment regarding the award when the vendor to receive the procurement award does not have a bid that is lowest of the collected bids.

28. The method of claim 26 further comprising the step of automatically notifying the at least one potential vendor of the issuance of the award, including the identity of the vendor to receive the procurement award and the purchase order data.
